(19) United States
(12) Patent Application Publication
(10) Pub. No.: US 2015/0229358 A1
(43) Pub. Date: Aug. 13, 2015

(54) POWER LINE COMMUNICATION TRANSCEIVER AND POWER LINE COMMUNICATION METHOD

(71) Applicant: AISIN SEIKI KABUSHIKI KAISHA, Kariya-shi, Aichi-ken (JP)

(72) Inventor: Sacha Vrazic, Paris (FR)

(73) Assignee: AISIN SEIKI KABUSHIKI KAISHA, Kariya-shi, Aichi-ken (JP)

(21) Appl. No.: 14/423,597

(22) PCT Filed: Sep. 18, 2013
(86) PCT No.: PCT/JP2013/005502

§ 371 Date: Feb. 24, 2015

(30) Foreign Application Priority Data
Sep. 20, 2012 (JP) 2012-206932

(51) Int. Cl. H04B 3/54; H04L 5/00; H04B 3/46

(52) U.S. Cl. CPC H04B 3/54; H04B 3/46; H04L 5/0062; H04L 5/0048; H04B 2203/5425

(57) ABSTRACT

One embodiment of the present invention provides a transceiver for power line communication, including: a transmission unit configured to transmit a signal; and a reception unit configured to estimate characteristics of a transmission path. Further, another embodiment of the present invention provides a power line communication method, including the steps of: estimating transmission path characteristics; generating an interference avoiding mask based on interference of the estimated transmission path characteristics; selecting or cancelling, through use of the interference avoiding mask, a sub-carrier of a signal to be transmitted; and transmitting the signal.

### TECHNICAL FIELD

The present invention relates to a transceiver for power line communication and a power line communication method, and more particularly, to a technology of cognitive short-range power line communication through a power line.

### BACKGROUND ART

Communication through a power line (power line communication) is a technology, with which data is encoded into a signal, and the encoded signal is transmitted/received through the power line in a frequency band that is not used to supply electricity. In the power line communication, a signal transmitted/received through the power line is affected by interference, fading, noise, and the like, which are caused by various devices connected to the power line.

In Patent Literature 1, there is disclosed a technology, which accomplishes, without requiring a user to set special settings, communication between devices that are not capable of communicating directly over a power line. In Patent Literature 2, there are disclosed a power line communication system, which controls data transmission/reception through the power line, and a technology of controlling nose component removal for removing a noise component that corrupts data transmitted/received through the power line. Patent Literature 2 particularly relates to a technology, with which a noise component induced into the power line is extracted, and is removed by forming a cancelling signal that is in the opposite phase to that of the noise component.

### CITATION LIST

### Patent Literature

PTL 1: Japanese Patent Application Laid-Open No. 2010-21954

PTL 2: Japanese Patent Application Laid Open No. 2009-21678

### SUMMARY OF INVENTION

### Technical Problem

In a power line communication, in light of leaking radio waves, in order to transmit a signal in a relatively low frequency band (specifically, 30 MHz or less), the maximum possible data throughput is limited. The performance of the power line communication is also limited by impulsive noise generated in the power line which is random, non-stationary, and intense. A device capable of reliable communication at a high bit rate despite noise, interference, and fading along a power line that is the transmission path is therefore wanted.

Patent Literature 1 does not disclose a technology that improves performance in the power line, which is in a situation where noise, interference, and fading affect strongly. Patent Literature 2 lessens the effect of noise in a transmission path by adding, to an input signal, a signal with the opposite amplitude to that of a noise component, and transmitting the resultant signal, but does not reduce the effects of impulsive noise and transmission path distortion, which deteriorate performance. A technology, with which the power line communication at a high bit rate is accomplished, is therefore wanted.

### Solution to Problem

It is an object of the present invention to provide a transceiver for a power line communication and a power line communication method, with which communication at a high bit rate is accomplished even under a harsh communication environment such as a power line at the low signal-to-noise ratio and the negative signal-to-interference ratio. One embodiment of the present invention is a transceiver for a power line communication, including: a transmission unit configured to transmit a signal; and a reception unit configured to receive a signal and to estimate transmission path characteristics. Further, another embodiment of the present invention is a power line communication method, including: estimating transmission path characteristics; generating an interference avoiding mask based on interference of the estimated transmission path characteristics; selecting or cancelling, through use of the generated interference avoiding mask, a sub-carrier of a signal to be transmitted; and transmitting the signal.

### BRIEF DESCRIPTION OF DRAWINGS

FIG. 1 is a schematic diagram illustrating a system for cognitive short-range communication through a power line according to an embodiment of the present invention.

FIG. 2 is a block diagram of each transceiver according to the embodiment of the present invention.

FIG. 3 is an operation timing chart illustrating the transmission of an OFDM signal from a first transceiver to a second transceiver according to the embodiment of the present invention.

FIG. 4 is a block diagram of an interference estimation unit in each transceiver according to the embodiment of the present invention.

FIG. 5A is a collection of diagrams illustrating the embodiment of the present invention, and includes a graph of a spectrum of complex baseband signals detected, a schematic diagram of an interference avoiding mask, and a graph of the spectrum of each allocated sub-carrier.

FIG. 5B is a schematic diagram illustrating a sub-carrier that is allocated by multiplying a modulated sub-carrier by the interference avoiding mask according to the embodiment of the present invention.

FIG. 6 is a schematic diagram illustrating transmission path characteristics that are estimated and transmission path characteristics that are predicted according to the embodiment of the present invention.

FIG. 7 is a flow chart illustrating an OFDM signal transmitting method according to the embodiment of the present invention.

FIG. 8 is a block diagram illustrating an example of clock synchronization, timing synchronization, and frequency synchronization.

FIG. 9 is a block diagram of a transmission path characteristics estimation unit in each transceiver according to the embodiment of the present invention.

FIG. 10 is a flow chart illustrating an OFDM signal receiving method according to the embodiment of the present invention.

### DESCRIPTION OF EMBODIMENT

An exemplary embodiment for carrying out the present invention is described in detail below with reference to the drawings. Note that, dimensions, materials, shapes, the relative positions of components, and the like that are mentioned in the following embodiment can be changed arbitrarily to suit the structure of a device to which the present invention is applied, or various conditions. The scope of the present invention is not limited to a mode that is described concretely in the following embodiment, unless otherwise specially noted. Components that have the same functions are denoted by the same reference symbols throughout the drawings referred to in the following description, and repetitive descriptions thereof may be omitted.

<Outline of a System 100>

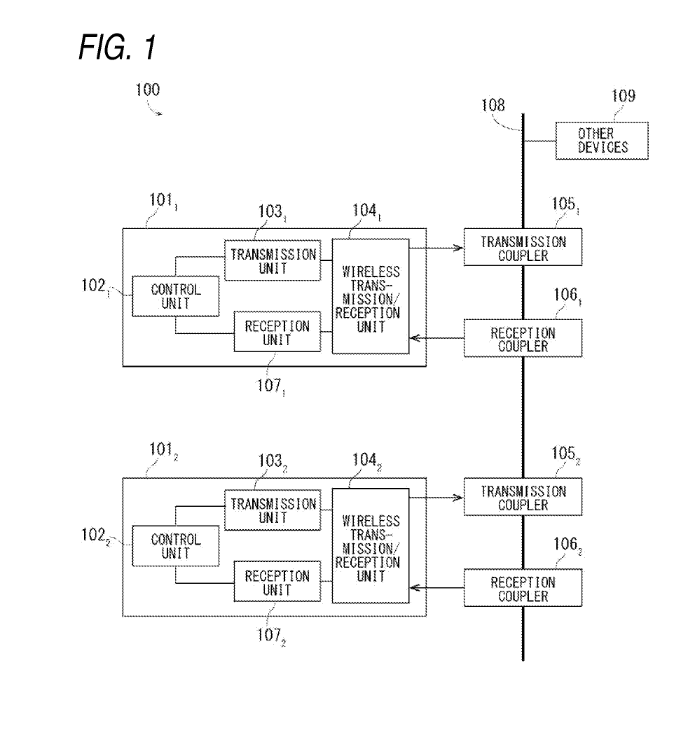

FIG. 1 is a schematic diagram illustrating a system 100 for cognitive short-range power line communication through a power line according to an embodiment of the present invention.

The system 100 includes a first transceiver 101₁ and a second transceiver 101₂ which communicate to and from each other through a power line 108. Transmission couplers 105 and reception couplers 106 which communicate to and from the first transceiver 101₁ and the second transceiver 101₂ are connected to the power line 108. Other devices 109 such as a motor and an inverter are also connected to the power line 108.

Suffixes “₁” and “₂” attached to reference symbols in the detailed description of the invention and the drawings are for clarifying that a component with “₁” and a component with “₂” relate to the first transceiver 101₁ and the second transceiver 101₂, respectively. Components denoted by the same reference symbol have the same function and configuration. The suffixes may be omitted as appropriate.

The first transceiver 101₁ and the second transceiver 101₂ are cognitive transceivers for power line communication that have a full duplex communication function which allows for simultaneous transmission and reception at the same center frequency. The first transceiver 101₁ and the second transceiver 101₂ are capable of learning and managing the communication state instantly. The first transceiver 101₁ and the second transceiver 101₂ estimate transmission path characteristics and make compensation accordingly.

Main transmission path characteristics in power line communication are an interference component and a transmission path distortion component. A factor of interference that is focused on here is impulsive noise which has a certain power locally at a certain frequency and which deteriorates the performance of a transmission path significantly. “Interference of transmission path characteristics” is an effect of an interference component present in a transmission path that is added to a signal. “Transmission path distortion of transmission path characteristics” is an effect of a transmission path distortion component (transmission path transfer function) that distorts a signal.

The first transceiver 101₁ and the second transceiver 101₂ have, in order to accomplish high-speed and reliable power line communication, a function of allocating a sub-carrier when transmitting transmission data while avoiding interference by detecting a transmission path and estimating interference of transmission path characteristics, and a pre-equalization processing function for equalizing transmission path distortion of transmission path characteristics in advance.

The first transceiver 101₁ and the second transceiver 101₂ operate in two modes, a “transmission mode” and a “reception mode”.

In the transmission mode, the first transceiver 101₁ and the second transceiver 101₂ each transmit an orthogonal frequency division multiplexing (OFDM) signal through the power line 108 to the transceiver 101 at the other end. At the same time as the transmission, the first transceiver 101₁ and the second transceiver 101₂ enable full duplex communication to receive the transmitted signal to which distortion due to transmission path distortion of transmission path characteristics is added as well as noise and interference. The first transceiver 101₁ and the second transceiver 101₂ in the reception mode each receive an OFDM signal transmitted from the transceiver at the other end. The first transceiver 101₁ and the second transceiver 101₂ detect interference of transmission path characteristics in the transmission mode and the reception mode both.

The first transceiver 101₁ and the second transceiver 101₂ each include a control unit 102, a transmission unit 103, a wireless transmission/reception unit 104, and a reception unit 107.

The control unit 102 is a computer that includes a CPU, a storage device and others and is configured to control the transmission unit 103, the wireless transmission/reception unit 104 and the reception unit 107 based on an instruction of software. The control unit 102 has a function of generating digital (or analog) data to be transmitted (hereinafter referred to as “transmission data”) and a function of processing data that is received from the other transceiver (hereinafter referred to as “reception data”) in a manner that varies depending on relevant application software. Transmission data and reception data are image data, audio data, or the like.

When an OFDM signal is to be transmitted to the other transceiver, the control unit 102 controls the timing of burst transmission by the transmission unit 103 and the wireless transmission/reception unit 104. At the same time as the timing control, the control unit 102 controls a function of detecting interference of transmission path characteristics and a function of estimating transmission path distortion of transmission path characteristics, which are executed by the reception unit 107.

The transmission unit 103 generates an OFDM signal by performing digital processing on transmission data as instructed by the control unit 102, and supplies the OFDM signal to the wireless transmission/reception unit 104.

The wireless transmission/reception unit 104 performs, on an OFDM signal supplied from the transmission unit 103, up-converting processing, DA conversion processing, low pass filter processing, amplifying processing and the like as needed, and transmits the resultant signal by wireless transmission to the relevant transmission coupler 105 connected to the power line 108. The wireless transmission/reception unit 104 also receives an OFDM signal that has been transmitted from the other transceiver and then transmitted by wireless transmission from the relevant reception coupler 106, performs amplifying processing, filtering processing, AD conversion processing, down-converting processing and the like as needed, and supplies the resultant signal to the reception unit 107.

The reception unit 107 generates reception data by receiving, through the wireless transmission/reception unit 104, an OFDM signal transmitted from the other transceiver 101 and performing given processing as instructed by the control unit 102. The reception unit 107 detects the presence of interference of transmission path characteristics for a given period, and estimates transmission path distortion of transmission path characteristics by receiving an OFDM signal that has been transmitted from the transmission unit 103 as instructed by the control unit 102.

Communication between the wireless transmission/reception unit 104 and the relevant transmission coupler 105 and communication between the wireless transmission/reception unit 104 and the relevant reception coupler 106 are not limited to wireless communication, and can be wired communication. The transmission couplers 105 and the reception couplers 106 do not need to be separate components, and the same coupler may be used to separate transmission signals from reception signals.

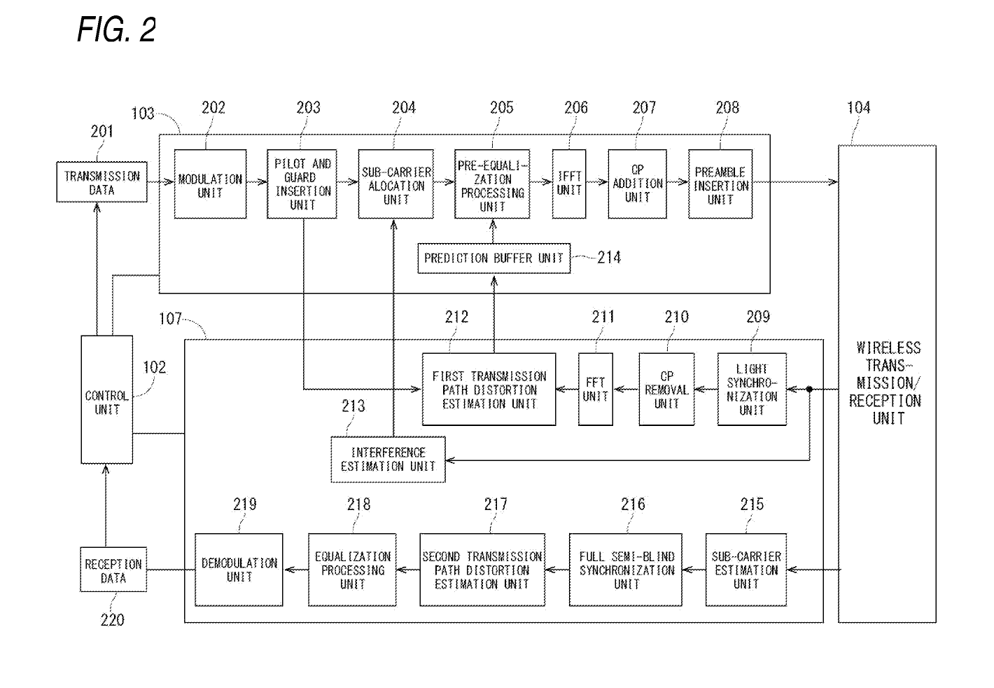

FIG. 2 is a block diagram of each transceiver 101 according to the embodiment.

The transmission unit 103 includes a modulation unit 202, a pilot and guard insertion unit 203, a sub-carrier allocation unit 204, a pre-equalization processing unit 205, an IFFT unit 206, a CP addition unit 207, a preamble insertion unit 208, and a prediction buffer unit 214.

The modulation unit 202 modulates, for each sub-carrier, transmission data 201 supplied from the control unit 102, by a modulation method such as BPSK, QPSK, PSK-M, QAM, or QAM-M, to parallelize the data. The pilot and guard insertion unit 203 inserts, into a symbol string obtained in the modulation unit 202, in a frequency domain, a pilot sub-carrier for synchronization processing and equalization processing, and a guard sub-carrier for the prevention of intersymbol interference.

The sub-carrier allocation unit 204 selects or cancels a sub-carrier, based on an interference avoiding mask that is supplied from the reception unit 107. The pre-equalization processing unit 205 equalizes in advance (“pre-equalization processing”) a symbol string that has a sub-carrier allocated thereto, based on current transmission path distortion that is predicted by the prediction buffer unit 214 from past transmission path distortion of transmission path characteristics that is estimated by the reception unit 107.

The IFFT unit 206 processes the entire symbol string at once by inverse fast Fourier transform (IFFT) in order to execute OFDM modulation. The CP addition unit 207 adds a cyclic prefix (CP) for helping synchronization. The preamble insertion unit 208 couples short and long preambles for frame synchronization, timing synchronization, and frequency synchronization, to thereby generate an OFDM signal.

The OFDM signal is supplied to the wireless transmission/reception unit 104, and is transmitted through the power line 108 to the other transceiver 101. Those functions of the transmission unit 103 are under control of the control unit 102.

An OFDM signal in this embodiment includes, for example, an OFDM frame to which preambles are coupled. A single OFDM frame is a string of N OFDM symbols each including 640 sub-carriers. A pilot carrier has four different values, [1, j, −1, −j], and one pilot sub-carrier is inserted for every twelve modulated data symbols, with each inserted pilot sub-carrier taking a different value. The 640 sub-carriers include 400 data sub-carriers, 65 guard sub-carriers, and 47 pilot sub-carriers, and additional 128 cyclic prefixes which are a repeat of the last 128 samples thereof. The short and long preambles conform to the IEEE 802.11 standard. The present invention is in no way limited to this example.

The reception unit 107 includes a light synchronization unit 209, a CP removal unit 210, an FFT unit 211, a first transmission path distortion estimation unit 212, an interference estimation unit 213, a sub-carrier estimation unit 215, a full semi-blind synchronization unit 216, a second transmission path distortion estimation unit 217, an equalization processing unit 218, and a demodulation unit 219.

The light synchronization unit 209 receives an OFDM signal transmitted from the transmission unit 103 of its own transceiver 101, and lightly synchronizes the OFDM signal. The CP removal unit 210 removes a cyclic prefix (CP) from the synchronized OFDM signal. The FFT unit 211 breaks the signal from which the CP has been removed into sub-carriers by fast Fourier transform (FFT).

The first transmission path distortion estimation unit 212 estimates transmission path distortion of transmission path characteristics (transmission path transfer function) based on the obtained sub-carriers and known symbols that are supplied from the transmission unit 103, and supplies the estimated transmission path distortion to the prediction buffer unit 214 of the transmission unit 103. The interference estimation unit 213 detects the presence of interference of transmission path characteristics (impulsive noise) through the wireless transmission/reception unit 104, and supplies an interference avoiding mask to the transmission unit 103.

The sub-carrier estimation unit 215 receives an OFDM signal transmitted from the other transceiver and estimates, by a semi-blind estimation method, sub-carriers allocated in the received OFDM signal. The full semi-blind synchronization unit 216 synchronizes the received OFDM signal based on a preamble in the received OFDM signal. The second transmission path distortion estimation unit 217 estimates transmission path distortion of transmission path characteristics on the received OFDM signal.

The equalization processing unit 218 processes the received OFDM signal by equalization processing based on the estimated transmission path distortion. The demodulation unit 219 demodulates the equalized signal, thereby generating reception data 220, and supplies the reception data 220 to the control unit 102.

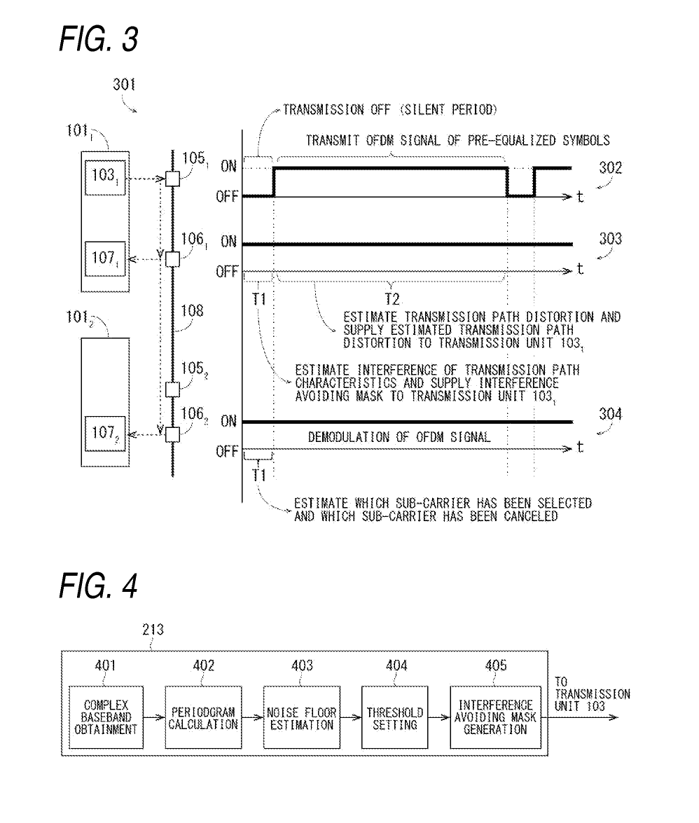

FIG. 3 is an operation timing chart of the transmission of an OFDM signal from the first transceiver 101₁ in the transmission mode to the second transceiver 101₂ in the reception mode.

In the example of FIG. 3, an OFDM signal is transmitted from the first transceiver 101₁ and received by the second transceiver 101₂. The first transceiver 101₁ is the “transmission-side” transceiver 101 and the second transceiver 101₂ is the “reception-side” transceiver 101.

In FIG. 3, the transmission unit 103₁ of the first transceiver 101₁ transmits an OFDM signal to the second transceiver 101₂ via the transmission coupler 105₁ connected to the power line 108. The transmitted OFDM signal is received by the reception unit 107₁ of the first transceiver 101₁ and the reception unit 107₂ of the second transceiver 101₂ via the reception coupler 106₁ and the reception coupler 106₂, respectively.

Timing charts 302 to 304 illustrate the operation timing of the transmission unit 103₁ and reception unit 107₁ of the first transceiver 101₁, and the operation timing of the reception unit 107₂ of the second transceiver 101₂, respectively. Each horizontal axis in FIG. 3 represents a time axis t. The transmission of an OFDM signal from the transmission unit 103₁ of the first transceiver 101₁ is executed in bursts.

The first transceiver 101₁ in the transmission mode does not transmit an OFDM signal from the transmission unit 103₁ to the second transceiver 101₂ for a given period T1 (hereinafter referred to as “silent period T1”). The silent period T1 can be, for example, a period equal in length to three OFDM symbols.

In the silent period T1, the reception unit 107₁ of the first transceiver 101₁ monitors the transmission path via the reception coupler 106₁ to detect the presence of interference of transmission path characteristics. The reception unit 107₁ of the first transceiver 101₁ generates an interference avoiding mask based on information of the detected interference, and supplies the generated interference avoiding mask to the transmission unit 103₁ of the first transceiver 101₁. The interference avoiding mask is used by the transmission unit 103₁ of the first transceiver 101₁ to select and cancel sub-carriers to be transmitted.

Similarly, the reception unit 107₂ of the second transceiver 101₂ in the reception mode monitors the transmission path via the reception coupler 106₂ in the silent period T1, where the reception unit 107₁ of the first transceiver 101₁ searches for the presence of interference of transmission path characteristics, to detect the presence of interference of transmission path characteristics. This enables the second transceiver 101₂ to estimate what interference avoiding mask is used in the first transceiver 101₁ and, consequently, to estimate which sub-carrier is selected and which sub-carrier is cancelled in the first transceiver 101₁ as the transmission-side transceiver.

In a given period T2 which follows the silent period T1 (hereinafter referred to as “transmission period T2”), the transmission unit 103₁ of the first transceiver 101₁ transmits to the second transceiver 101₂ an OFDM signal that has undergone sub-carrier selecting and canceling processing which uses the interference avoiding mask and pre-equalization processing which uses predicted transmission path distortion of transmission path characteristics.

The reception unit 107₁ of the first transceiver 101₁ receives in the transmission period T2 the OFDM signal transmitted from transmission unit 103₁ of the first transceiver 101₁ to the second transceiver 101₂. In the transmission period T2, the reception unit 107₁ of the first transceiver 101₁ estimates transmission path characteristics from the received OFDM signal and supplies the estimated transmission path characteristics to the prediction buffer unit 214 of the transmission unit 103₁ of the first transceiver 101₁.

The reception unit 107₂ of the second transceiver 101₂ receives in the transmission period T2 the OFDM signal transmitted from the first transceiver 101₁, demodulates the OFDM signal, and generates reception data.

In a period where one transceiver 101 is in the transmission mode and does not transmit an OFDM signal (i.e., the silent period T1), the reception unit 107 of the transceiver 101 monitors a transmission path and detects interference of transmission path characteristics. In the case where there is interference (impulsive noise), the reception unit 107 of the transceiver 101 detects a frequency element that has a given power.

<Outline of the Interference Estimation Unit 213>

FIG. 4 is a block diagram of the interference estimation unit 213 configured to generate an interference avoiding mask, which is used to select and cancel sub-carriers.

The interference estimation unit 213 includes a complex baseband signal obtainment unit 401, a periodogram calculation unit 402, a noise floor estimation unit 403, a threshold setting unit 404 and an interference avoiding mask generation unit 405.

The complex baseband signal obtainment unit 401 monitors the state of a transmission path via the reception coupler 106, and obtains a complex baseband signal of the transmission path. The periodogram calculation unit 402 calculates a periodogram through use of the obtained complex baseband signal.

The noise floor estimation unit 403 estimates the noise floor from the result of the periodogram calculation. The threshold setting unit 404 sets a threshold suitable for relevant application software. The interference avoiding mask generation unit 405 generates an interference avoiding mask that is equal in length to the number of sub-carriers, and supplies the generated mask to the transmission unit 103.

A periodogram is an estimated power spectral density. The periodogram calculation unit 402 calculates a periodogram by the following Expression 1.

$$S ( {e}^{j ω} ) = \frac{\frac{1}{2 π N} {\vert {\sum }_{n = 1}^{N} {x}_{n} {w}_{n} {e}^{- j ω n} \vert}^{2}}{\frac{1}{N} {\sum }_{n = 1}^{N} {\vert {w}_{n} \vert}^{2}} \qquad [ Math . 1 ]$$

In Expression 1, S(e^{jω}) represents an estimated power spectral density, ω represents the frequency, N represents a positive integer, χ represents a complex baseband signal, and w represents a window function used (for example, the Hanning window). The periodogram calculation uses fast Fourier transform (FFT).

The noise floor is necessary to set an appropriate threshold that is used to detect the presence of interference. The noise floor estimation unit 403 can obtain the noise floor by (1) sorting, in descending order, N power spectral densities (PSDs) which have been obtained through the periodogram calculation, and (2) calculating an average of the sum of the latter quarter of the N power spectral densities (PSDs) sorted in descending order. The N power spectral densities (PSDs) are sorted in descending order in order to put a relatively high PSD toward the start of a PSD vector and a relatively low PSD toward the end of the PSD vector.

The noise floor is accordingly estimated by the following Expression 2.

$$NF = \frac{{\sum }_{i = 3 N / 4}^{N} {sortedPSD}_{i}}{\frac{N}{4}} \qquad [ Math . 2 ]$$

In Expression 2, NF represents the noise floor, N represents the number of power spectral densities, and sortedPSDi represents the power spectral densities sorted in descending order.

Once the noise floor is estimated, the threshold setting unit 404 sets a threshold suitable for relevant application software. Alternatively, the threshold may be a fixed value that is determined by a user in advance and stored in the transceiver 101 in advance. For example, the threshold may be set to 10 dB based on the estimated noise floor, or to the value of the estimated noise floor. A frequency that has a greater power spectral density than the set threshold is estimated as interference.

The interference avoiding mask is generated by the interference avoiding mask generation unit 405 so as to be equal in length to the number of sub-carriers excluding cyclic prefixes (512 sub-carriers in the example given above), and so as to have a value “0” for a frequency where there is interference and a value “1” for other frequencies. The number of values that are “1” in the interference avoiding mask and frequencies that have the value “1” are equal to the total number of sub-carriers transmitted minus cyclic prefixes and corresponding frequencies.

The detection of no interference means no frequencies that have a greater power spectral density than the threshold and, when it is the case, all 512 values of the interference avoiding mask are “1”. This is normal OFDM transmission.

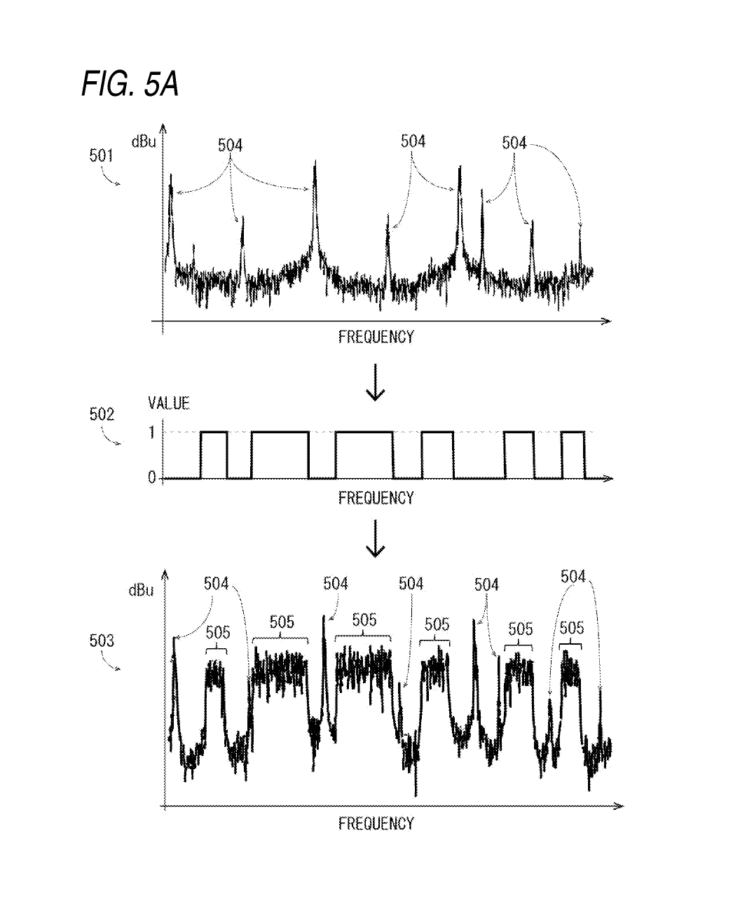

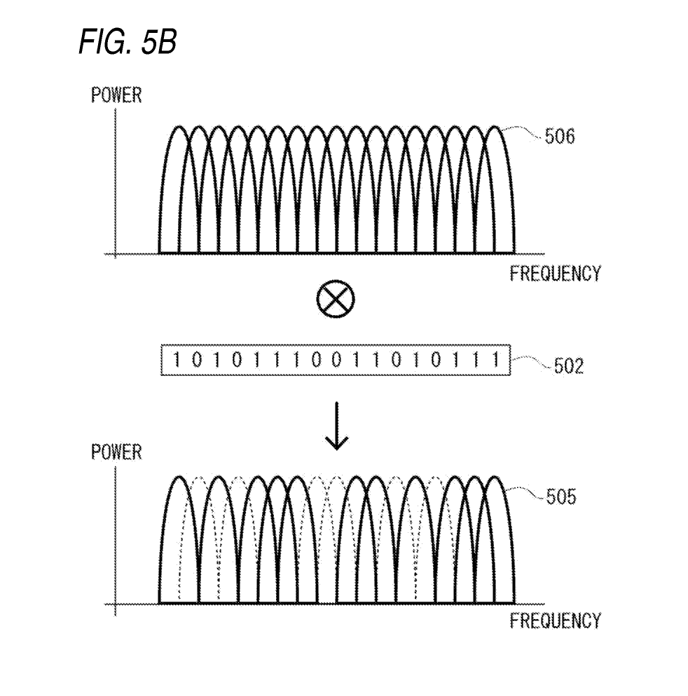

FIG. 5A is a collection of diagrams illustrating an example, and includes an actual graph of a complex baseband spectrum 501 which is detected by the interference estimation unit 213 and includes transmission path characteristics interference 504, a schematic diagram of an interference avoiding mask 502 generated from the complex baseband spectrum 501, and an actual graph of a sub-carrier spectrum 503 of sub-carriers that are allocated by the sub-carrier allocation unit 204 based on the interference avoiding mask.

The interference avoiding mask 502 has a value “0” for a frequency where there is the transmission path characteristics interference 504, and has a value “1” for other frequencies. The interference avoiding mask 502 is supplied to the transmission unit 103 to be multiplied simply by modulated sub-carriers 506 as illustrated in FIG. 5B. Sub-carriers are selected and cancelled in this manner, with the result that sub-carriers 505 free of the interference 504 are allocated to an OFDM signal that is sent to the other transceiver 101. The generated interference avoiding mask is also used to estimate transmission path distortion of transmission path characteristics as described later.

Each transceiver 101 according to this embodiment can thus adapt to a change in transmission path characteristics in real time, and is capable of transmitting an OFDM signal that is substantially free of interference of transmission path characteristics (impulsive noise).

The interference estimation unit 213₂ of the reception unit 107₂ in the second transceiver 101₂, which receives an OFDM signal from the first transceiver 101₁, can generate in the silent period T1 the same interference avoiding mask that is generated in the first transceiver 101₁, as described above.

The number of values that are “1” in the interference avoiding mask and frequencies that have the value “1” are equal to the total number of sub-carriers transmitted and corresponding frequencies. The sub-carrier estimation unit 215₂ of the reception unit 107₂ in the second transceiver 101₂, where an OFDM signal is received, can therefore estimate which sub-carrier has been selected and which sub-carrier has been cancelled in the received OFDM signal.

When the interference estimation unit 213 is to generate an interference avoiding mask is not limited to the silent period T1 and can be any period. Specifically, the interference estimation unit 213 may detect interference in a transmission path and generate and store an interference avoiding mask in the transmission period T2 to use the stored mask when the next OFDM signal is generated. In this case, the reception-side transceiver 101 constantly monitors the transmission path, detects the presence of interference, generates an interference avoiding mask from moment to moment, and stores the generated masks in order to understand in the reception mode which sub-carrier has been selected and which sub-carrier has been cancelled. The reception-side transceiver 101 can know which sub-carrier has been selected and which sub-carrier has been cancelled in a received OFDM signal by using an interference avoiding mask that has been generated at the time (or close to the time) when the OFDM signal has been sent.

<Outline of the Pre-equalization Processing Function>

The transmission unit 103₁ of the first transceiver 101₁ in the transmission mode transmits an OFDM signal to the second transceiver 101₂ in the transmission period T2. Meanwhile, the reception unit 107₁ of the first transceiver 101₁ receives in the transmission period T2 the transmitted OFDM signal itself and uses the received signal to estimate transmission path distortion of transmission path characteristics. The transmission unit 103₁ of the first transceiver 101₁ uses the estimated transmission path distortion to perform equalization processing in advance (“pre-equalization processing”) on a symbol to be transmitted next.

In each transceiver 101, the reception unit 107 receives from the transmission unit 103 information about an ODFM symbol to be transmitted (hereinafter the information is referred to as “known symbol”). It is with the knowledge of the known symbol that the reception unit 107 of the transceiver 101 can estimate transmission path distortion of transmission path characteristics. Pre-equalization processing is implemented as a result.

Performing equalization processing in advance on a signal to be transmitted in the transmission-side transceiver 101 has an advantage of increasing the signal-to-noise ratio (SNR) in the reception-side transceiver 101 from the case where equalization processing is performed by the reception-side transceiver 101 alone. The principle of the pre-equalization processing according to this embodiment is described below.

A signal Rₙ received by one transceiver 101 at one point in time is expressed generally by the following Expression 3.

Rₙ=SₙHₙ+Nₙ [Math. 3]

In Expression 3, Sₙ represents an unknown transmitted symbol, Hₙ represents transmission path distortion, and Nₙ represents noise added to a signal through the transmission path.

The pre-equalization processing is for multiplying, by the transmission-side transceiver 101, a symbol to be transmitted by, ideally, an inverse number of transmission path distortion, prior to transmission. Then a reception signal that has undergone the pre-equalization processing is expressed by the following Expression 4.

Rₙ=SₙGₙHₙ+Nₙ [Math. 4]

In Expression 4, Gₙ represents an inverse number of predicted transmission path distortion, and is expressed by the following Expression 5.

Gₙ=aₙe^{-jφ}^{ₙ} [Math. 5]

When predicted transmission path distortion is accurate, Gₙ serves as a pre-equalization coefficient which is an inverse number H⁻¹ of true transmission path distortion. In Expression 5, aₙ represents an amplitude coefficient and φₙ represents a phase coefficient.

As is understood from FIG. 2, an OFDM signal transmitted from the transmission unit 103 of one transceiver 101 is received by the reception unit 107 of this transceiver 101. The light synchronization unit 209 of the reception unit 107 can easily synchronize the received OFDM signal because the received OFDM signal is a signal generated and transmitted by its own transceiver 101, because the interference avoiding mask used to select and cancel sub-carriers is known, because the same voltage controlled oscillator is used to drive a wireless board, because there is no need for carrier frequency recovery and tracking, and because the time to transmit timing and symbols is known.

Phase compensation, however, needs to be considered. A phase offset θ_{d} is in linear relation to frequency and is expressed generally by the following Expression 6.

$$θ ( f ) = {θ}_{d} + \frac{d θ}{d f} f \qquad [ Math . 6 ]$$

In Expression 6, θ_{d} represents a fixed phase offset, and is estimated by obtaining a phase difference between a known symbol and a received symbol which has been distorted due to the effect of transmission path characteristics. The fixed phase offset θ_{d} is calculated as an average of this phase difference obtained for every symbol. The light synchronization unit 209 makes phase compensation in this manner, thereby accomplishing synchronization.

When the light synchronization unit 209 accomplishes synchronization, the received symbol that has been distorted is restored, and the CP removal unit 210 removes cyclic prefixes (CPs) from the symbol. Thereafter, the FFT unit 211 executes fast Fourier transform (FFT) to convert the symbol into a frequency domain, and the signal is broken into sub-carriers. The first transmission path distortion estimation unit 212 then executes zero forming equalization processing through use of a known symbol, thereby estimating transmission path distortion of transmission path characteristics with ease. The estimated transmission path distortion is supplied to the prediction buffer unit 214, where the supplied distortion is stored.

Transmission path distortion estimated from a received OFDM symbol (OFDM signal) that has been transmitted at a time t1 cannot be used in the pre-equalization processing at the time t1, but can be used in the pre-equalization processing that is executed to transmit an OFDM symbol at a subsequent time t2 (>t1).

Although it is an option to use previously estimated transmission path distortion of transmission path characteristics as it is, predicting the current transmission path distortion from previously estimated transmission path distortion is desirable because transmission path distortion can change between successive OFDM symbols (OFDM signals).

The prediction buffer unit 214 of the transmission unit 103 stores transmission path distortion components of transmission path characteristics that have been estimated by the first transmission path distortion estimation unit 212 at past times t₀₋₂ and t₀₋₁ (t₀₋₂<t₀₋₁), and predicts transmission path distortion at the current time t₀. The prediction buffer unit 214 includes a circular buffer and the like.

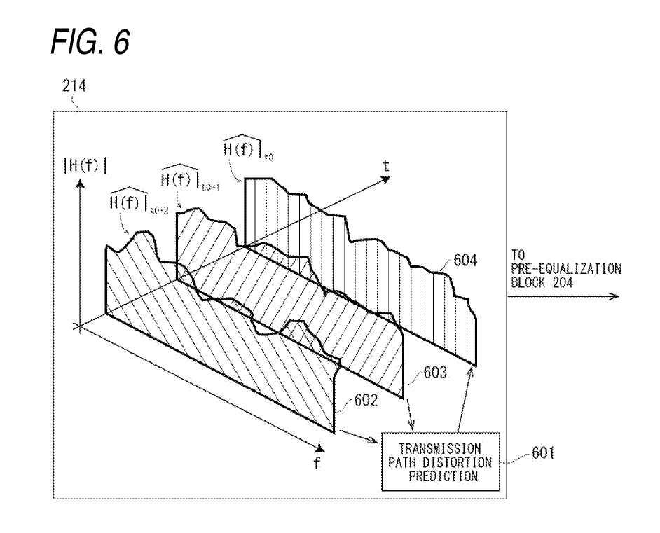

FIG. 6 is a schematic diagram illustrating an example of graphs 602 and 603 of transmission path characteristics transmission path distortion H(f)̂|t₀₋₂ and transmission path characteristics transmission path distortion H(f)̂|t₀₋₁, which have been estimated at the past times t₀₋₂ and t₀₋₁ (t₀₋₂<t₀₋₁) and stored in the prediction buffer unit 214, and a graph 604 of transmission path distortion H(f)̂|t₀, which is predicted for the current time t₀ by the transmission path distortion prediction unit 601 of the prediction buffer unit 214 based on the graphs 602 and 603. The symbol “̂” is a hat symbol and indicates that the value is an estimate.

In FIG. 6, an axis running toward the upper right corner in the back of the drawing is a time axis t, an axis running toward the lower right corner on the near side of the drawing is a frequency axis f, and an axis running upward toward the top of the drawing represents an absolute value |H(f)| of estimated or predicted transmission path distortion.

The transmission path distortion prediction unit 601 of the prediction buffer 241 predicts transmission path distortion H(f)̂|t₀ necessary for the pre-equalization processing of an OFDM symbol to be transmitted at the current time t₀ by multiplying the estimated transmission path distortion H(f)̂|t₀₋₂ and the estimated transmission path distortion H(f)̂|t₀₋₁, which relate to OFDM symbols (or OFDM signals or OFDM bursts. Which type is used can be changed to suit relevant application software) received at the past times t₀₋₂ and t₀₋₁, by a given weight and combining the results with each other.

The transmission path distortion prediction unit 601 may use prediction architecture of any type. An example of architecture that can be used is expressed by the following Expression 7.

[symbol]

ₜ₀=a(f) [symbol] ₜ₀₋₂+(1−a(f)) [symbol] ₜ₀₋₁ [Math. 7]

A weight function α(f) is a vector of a constant that varies from one frequency bin to another.

The weight function α(f) may be a constant “⅓” because the effect of transmission path distortion of transmission path characteristics that is estimated at the past time t₀₋₁, which is closer to the current time t₀, is considered to be greater than the effect of transmission path distortion estimated at the past time t₀₋₂, which is farther back in the past. The weight function α(f) may also be set to an appropriate value that is obtained experientially, or may be calculated.

An inverse number of transmission path distortion predicted by the transmission path distortion prediction unit 601 in this manner, namely, inverse transmission path distortion {H(f)̂|t₀₋₁}⁻¹=G₀, is supplied to the pre-equalization processing unit 205 of the transmission unit 103 and is used for the pre-equalization processing.

<OFDM Signal Transmission Method>

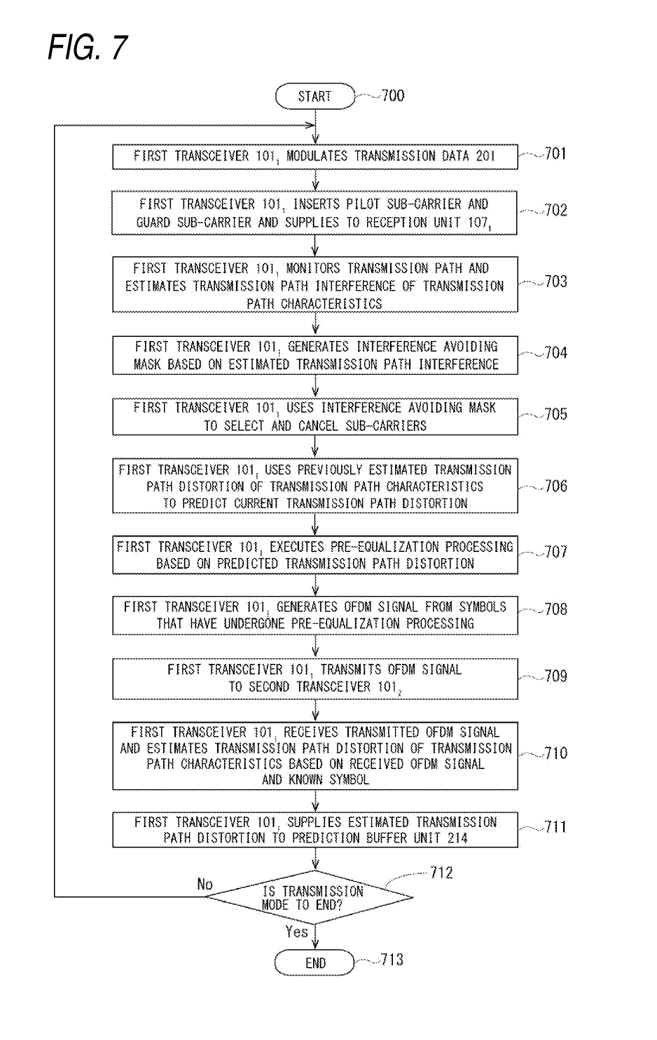

FIG. 7 is a flow chart illustrating a method of transmitting an OFDM signal from the first transceiver 101₁ to the second transceiver 101₂ through the power line 108.

At the start of OFDM signal transmission from the first transceiver 101₁ to the second transceiver 101₂ through the power line 108 (Step 700), the transmission unit 103₁ of the first transceiver 101₁ in the transmission mode modulates the transmission data 201 in order to generate an OFDM signal to be transmitted to the second transceiver 101₂ (Step 701). The transmission unit 103₁ of the first transceiver 101₁ inserts a pilot sub-carrier and a guard sub-carrier to a modulated symbol, and supplies the symbol to the reception unit 107₁ of the first transceiver 101₁ (Step 702).

In the silent period T1 where the transmission unit 103₁ of the first transceiver 101₁ does not transmit an OFDM signal, the reception unit 107₁ of the first transceiver 101₁ monitors a transmission path via the reception coupler 106₁ and the wireless transmission/reception unit 104₁, and estimates transmission path interference of transmission path characteristics (Step 703). The reception unit 107₁ of the first transceiver 101₁ generates an interference avoiding mask based on the estimated transmission path interference, and supplies the generated mask to the transmission unit 103₁ of the first transceiver 101₁ (Step 704).

The transmission unit 103₁ of the first transceiver 101₁ uses the sub-carrier allocation unit 204 and the interference avoiding mask to select and cancel sub-carriers (Step 705). The transmission unit 103₁ of the first transceiver 101₁ predicts the current transmission path distortion through use of transmission path distortion of transmission path characteristics that has been estimated in the past by the reception unit 107₁ of the first transceiver 101₁ (Step 706). The transmission unit 103₁ of the first transceiver 101₁ performs the pre-equalization processing on the symbol based on the predicted transmission path distortion (Step 707).

The transmission unit 103₁ of the first transceiver 101₁ generates an OFDM signal by performing IFFT processing, cyclic prefix (CP) adding processing, and preamble coupling processing on the symbol that has undergone the pre-equalization processing (Step 708). The transmission unit 103₁ of the first transceiver 101₁ transmits the generated OFDM signal to the second transceiver 101₂ via the wireless transmission/reception unit 104₁, the transmission coupler 105₁, and the power line 108 (Step 709).

The reception unit 107₁ of the first transceiver 101₁ receives the OFDM signal transmitted from the transmission unit 103₁ of the first transceiver 101₁, and estimates transmission path distortion of transmission path characteristics based on the received OFDM signal and a known symbol that is supplied from the transmission unit 103₁ of the first transceiver 101₁ (Step 710). The reception unit 107₁ of the first transceiver 101₁ supplies the estimated transmission path distortion to the prediction buffer unit 214 in the transmission unit 103₁ of the first transceiver 101₁ so that the estimated transmission path distortion is used in the next transmission (Step 711).

In the case where the transmission mode of the first transceiver 101₁ does not end yet (“No” in Step 712), the flow is repeated from Step 701. In the case where the transmission mode of the first transceiver 101₁ is to end (“Yes” in Step 712), the transmission of OFDM signals from the first transceiver 101₁ to the second transceiver 101₂ ends (Step 713).

The functions of the transmission-side transceiver 101, in particular, the function of allocating a sub-carrier while avoiding interference (the sub-carrier allocation unit 204) and the function of performing equalization processing on a transmission symbol in advance (the pre-equalization processing unit 205), have been described. Functions that are involved in the reception of an OFDM signal by the reception-side transceiver 101 are described next.

<Reception of an OFDM Signal in the Reception-Side Transceiver 101>

The transceiver 101 that is in the reception mode turns off the transmission unit 103 of the transceiver 101 and receives an OFDM signal sent from the other transceiver 101 through the power line 108. OFDM frame synchronization, clock recovery, carrier recovery, phase synchronization, and timing synchronization are executed in order to extract the reception data 220 out of the OFDM signal sent.

The received OFDM signal may have undergone sub-carrier selection and cancellation in the transmission-side transceiver 101. It is therefore necessary to estimate, prior to synchronization processing, which sub-carrier has been allocated and sent in the received OFDM signal. This estimation is made by a semi-blind estimation method because information concerning that is not transmitted from the transmission-side transceiver 101. This embodiment proposes full semi-blind synchronization architecture.

OFDM signals are transmitted in bursts, which enables the reception-side transceiver 101 to estimate which sub-carrier has been allocated during a break in transmission. The sub-carrier estimation unit 215 of the reception-side transceiver 101 detects the presence of interference of transmission path characteristics as described above during a break in transmission, and generates an interference avoiding mask by the same principle that is described above. The reception-side transceiver 101 can thus estimate which sub-carrier is allocated in a received OFDM signal.

Thereafter, the full semi-blind synchronization unit 216 of the reception-side transceiver 101 executes synchronization processing for the received OFDM signal. OFDM frame synchronization is executed simply by obtaining correlation between the received data and a short preamble. After the correlation processing, a maximum peak is detected. The detected maximum peak indicates the start of an OFDM frame.

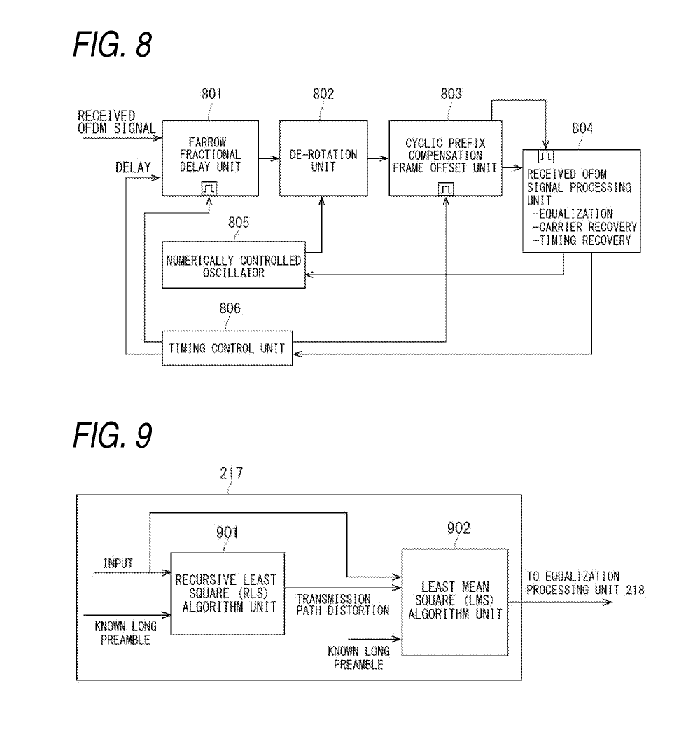

Once OFDM frame synchronization is complete, processing of clock synchronization, timing synchronization, and frequency synchronization is executed by technologies known to a person skilled in the art. FIG. 8 is a block diagram illustrating an example for clock synchronization, timing synchronization, and frequency synchronization. A Farrow fractional delay unit 801 synchronizes timing. Processing of synchronizing other parameters is executed, as is understood by a person skilled in the art, through use of a de-rotation unit 802, a cyclic prefix compensation frame offset unit 803, a received OFDM signal processing unit 804, a numerically controlled oscillator 805, a timing control unit 806, and the like.

With synchronization of every parameter completed in the full semi-blind synchronization unit 216 of the reception-side transceiver 101, the reception-side transceiver 101 can decode a received symbol. However, the effect of interference, fading, noise, and the like in the power line 108 is so profound that some of transmission path distortion of transmission path characteristics may not be estimated successfully and may remain even after the pre-equalization processing in the transmission-side transceiver 101, thereby distorting the transmitted OFDM signal. It is therefore preferred to additionally execute simple equalization processing in the reception-side transceiver 101.

The second transmission path distortion estimation unit 217 and equalization processing 218 of the reception-side transceiver 101 use a long preamble of the received OFDM signal for equalization processing. The equalization processing in the second transmission path distortion estimation unit 217 is to estimate transmission path distortion through use of a known preamble.

FIG. 9 is a block diagram of the second transmission path distortion estimation unit 217 of the reception unit 107 in the reception-side transceiver 101. The second transmission path distortion estimation unit 217 includes a recursive least square (RLS) algorithm processing unit 901 and a least mean square (LMS) algorithm processing unit 902.

First, for fast convergence, the recursive least square (RLS) algorithm processing (at unit 901) is performed on the input signal through use of a known long preamble, and transmission path distortion of transmission path characteristics is estimated. When fast convergence is accomplished after an approximately hundred samples, the estimation of transmission path distortion is continued further through use of the least mean square (LMS) algorithm processing (at unit 902).

The RLS algorithm processing (at unit 901), although capable of bringing about fast convergence, is high in complexity. For that reason, a switch to the LMS algorithm processing (at unit 902), which is low in complexity, is made once convergence is complete. Transmission path distortion estimated by the RLS algorithm processing unit 901 is supplied as an input to the LMS algorithm processing unit 902.

This double algorithm processing configuration has an advantage of reducing complexity while accomplishing fast convergence. Another advantage of the double algorithm processing configuration is a decrease in bit error rate (BER) ultimately on the order of ten times the decrease in normal equalization processing.

In the equalization processing unit 218 of the reception unit 107 of the reception-side transceiver 101, parameters necessary for equalization processing are a deductive filtering error εₖ^{p} at a time k, a transmission path distortion vector Hₖ=[h₀ . . . h_{N}]^{T} at the time k which has a length N (for example, N=32), an adaptive filter input sample xₖ at the time k, an adaptive filter input vector Yₖ=[xₖ, xₖ₋₁ . . . x_{k-N+1}]^{T} at the time k which has the length N, a step size μ (for example, μ=0.99), and a covariance matrix Rₖ⁻¹.

For the duration of a first (for example) hundred samples of the input signal, the RLS algorithm processing unit 901 estimates transmission path distortion through use of the RLS algorithm processing (at unit 901) which is expressed by the following Expression 8.

εₖ^{p}=χₖ−Hₖ₋₁^{RLS}^{^{T}}Yₖ

εₖ=εₖ^{p}(1+Yₖ^{T}Rₖ₋₁⁻¹Yₖεₖ)⁻¹

Hₖ^{RLS}=Hₖ₋₁^{RLS}+Rₖ₋₁⁻¹Yₖεₖ

Rₖ⁻¹=Rₖ₋₁⁻¹−Rₖ₋₁⁻¹Yₖ(1+Yₖ^{T}Rₖ₋₁⁻¹Yₖ)⁻¹Yₖ^{R}Rₖ₋₁⁻¹ [Math. 8]

When convergence is accomplished after the first hundred samples, transmission path distortion H^{k}^{RLS} estimated by the RLS algorithm processing unit 901 is supplied as an input Hₖ^{LMS}=Hₖ^{RLS} to the LMS algorithm processing unit 902, so that the estimation of transmission path distortion is continued through use of the following Expression 9.

εₖ^{p}=χₖ−Hₖ₋₁^{LMS}^{^{T}}Yₖ

Hₖ^{LMS}=Hₖ₋₁^{LMS}+μεₖ^{p}Yₖ [Math. 9]

The transmission path distortion estimated by the LMS algorithm processing unit 902 is ultimately used by the equalization processing unit 218 of the reception-side transceiver 101 to process the symbol by equalization processing.

The reception-side transceiver 101 is not limited to one that executes the synchronization processing and equalization processing described above. The reception-side transceiver 101 needs to include the sub-carrier estimation unit 215 in addition to the components of a normal transceiver, but may use synchronization processing and equalization processing of related art.

The demodulation unit 219 of the transmission-side transceiver 101 then demodulates the symbol that has undergone equalization processing, generates reception data, and supplies the reception data to the control unit 102.

<OFDM Signal Reception Method>

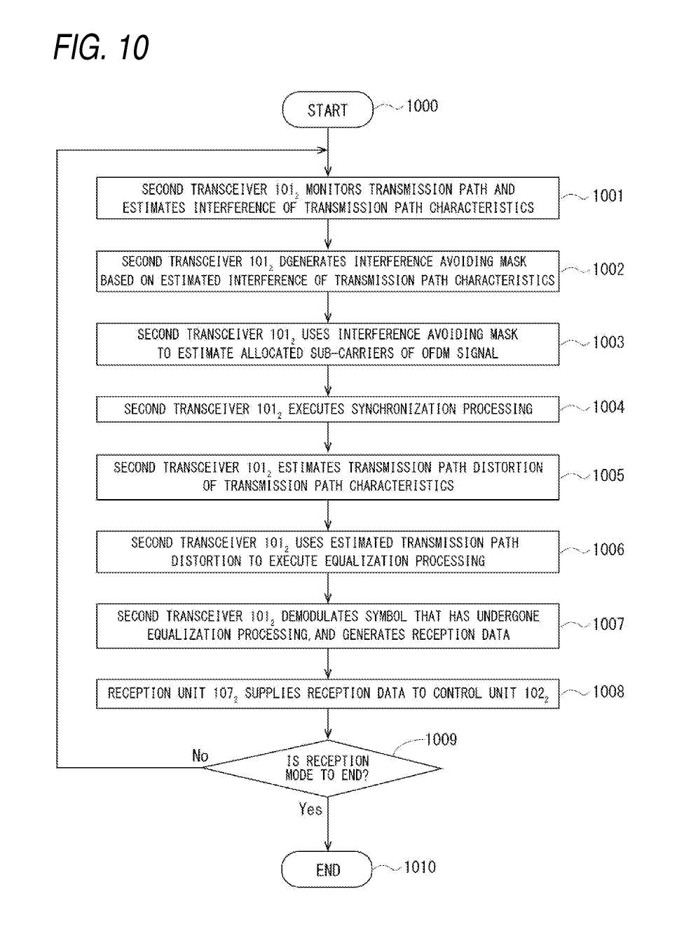

FIG. 10 is a flow chart illustrating a method of receiving an OFDM signal by the second transceiver 101₂.

The transmission of an OFDM signal from the first transceiver 101₁ to the second transceiver 101₂ through the power line 108 is started (Step 1000). In the silent period T1, where the transmission unit 103₁ of the first transceiver 101₁ does not transmit an OFDM signal, the reception unit 107₂ of the second transceiver 101₂ in the reception mode monitors the transmission path via the reception coupler 106₂ and the wireless transmission/reception unit 104₂, and estimates interference of transmission path characteristics (Step 1001).

The reception unit 107₂ of the second transceiver 101₂ generates an interference avoiding mask based on the estimated interference of transmission path characteristics (Step 1002). In the transmission period T2, the reception unit 107₂ of the second transceiver 101₂ uses the interference avoiding mask to estimate sub-carriers that are allocated to the OFDM signal transmitted from the first transceiver 101₁ (Step 1003).

The reception unit 107₂ of the second transceiver 101₂ executes processing of frame synchronization, timing synchronization, clock synchronization, and frequency synchronization for the received OFDM signal (Step 1004). The reception unit 107₂ of the second transceiver 101₂ estimates transmission path distortion of transmission path characteristics (Step 1005). The reception unit 107₂ of the second transceiver 101₂ uses the estimated transmission path distortion to execute equalization processing (Step 1006).

The reception unit 107₂ of the second transceiver 101₂ demodulates a symbol that has undergone the equalization processing, and generates reception data (Step 1007). The reception unit 107₂ of the second transceiver 101₂ supplies the reception data to the control unit 102₂ of the second transceiver 101₂ (Step 1008).

In the case where the reception mode of the second transceiver 101₂ does not end yet (“No” in Step 1009), the flow is repeated from Step 1001. In the case where the reception mode of the second transceiver 101₂ is to end (“Yes” in Step 1009), the reception of OFDM signals transmitted from the first transceiver 101₁ to the second transceiver 101₂ ends (Step 1010).

Transceivers according to an embodiment of the present invention can use any of hardware and software to implement the functions that have been described. An embodiment of the present invention is also applicable to short-range communication held through any power line. For instance, the present invention is applicable to power line communication within a house and within an automobile. Communication through a power line in an automobile to which various instruments are connected is particularly liable to be affected by interference, fading, noise, and the like. Transceivers according to an embodiment of the present invention are capable of reducing the effects of interference and such, and can favorably be used for power line communication within an automobile.

A transceiver for power line communication and power line communication method according to an embodiment of the present invention include a pre-equalization function and an interference avoidance function, and are capable of reliable communication at a high bit rate even under the effects of noise (interference) and distortion from a power line that is a transmission path.

This application claims priority from Japanese Patent Application No. 2012-206932, filed on Sep. 20, 2012, the content of which is incorporated herein as a part of this application.

### REFERENCE SIGNS LIST

100: cognitive short-range power line communication system, 101: transceiver, 102: control unit, 103: transmission unit, 104: wireless transmission/reception unit, 105: transmission coupler, 106: reception coupler, 107: reception unit, 108: power line, 109: other devices

1. A transceiver for power line communication, comprising:
a transmission unit configured to transmit a signal; and
a reception unit configured to receive a signal and to estimate characteristics of a transmission path.

2. A transceiver for power line communication according to claim 1, further comprising:
an interference estimation unit configured to generate an interference avoiding mask based on interference of the estimated transmission path characteristics; and
a sub-carrier allocation unit configured to select or cancel, through use of the interference avoiding mask, a sub-carrier of a signal to be transmitted.

3. A transceiver for power line communication according to claim 1, further comprising:
a transmission path distortion estimation unit configured to receive a signal that is transmitted by the transmission unit, and to estimate transmission path distortion of transmission path characteristics based on the received signal; and
a pre-equalization processing unit configured to equalize a signal to be transmitted in advance, through use of the estimated transmission path distortion.

4. A transceiver for power line communication according to claim 1, further comprising a sub-carrier estimation unit configured to generate an interference avoiding mask based on interference of the estimated transmission path characteristics, and to estimate allocated sub-carriers of the received signal through use of the interference avoiding mask.

5. A transceiver for power line communication according to claim 1,
wherein the transmission path is a power line,
wherein the signal is an OFDM signal, and
wherein the transceiver for power line communication is a cognitive transceiver for power line communication that has a full duplex communication function with which transmission and reception are executable concurrently at the same center frequency.

6. A transceiver for power line communication within an automobile, comprising:
a transmission unit configured to transmit a signal to a power line in the automobile;
a reception unit configured to receive a signal from the power line, and to estimate transmission path characteristics;
an interference estimation unit configured to generate an interference avoiding mask based on interference of the estimated transmission path characteristics;
a sub-carrier allocation unit configured to select or cancel, through use of the interference avoiding mask, a sub-carrier of a signal to be transmitted;
a transmission path distortion estimation unit configured to receive a signal that is transmitted by the transmission unit, and to estimate transmission path distortion of transmission path characteristics based on the received signal; and
a pre-equalization processing unit configured to equalize a signal to be transmitted in advance, through use of the estimated transmission path distortion.

7. A power line communication method, comprising the steps of:
estimating transmission path characteristics;
generating an interference avoiding mask based on interference of the estimated transmission path characteristics;
selecting or cancelling, through use of the interference avoiding mask, a sub-carrier of a signal to be transmitted; and
transmitting the signal.

8. A power line communication method according to claim 7, further comprising the steps of:
receiving the transmitted signal;
estimating transmission path distortion of transmission path characteristics based on the received signal; and
equalizing a signal to be transmitted in advance, through use of the estimated transmission path distortion.

9. A power line communication method according to claim 7, further comprising the steps of:
generating an interference avoiding mask based on interference of the estimated transmission path characteristics; and
estimating allocated sub-carriers of the received signal through use of the interference avoiding mask.
